(19) United States
(12) Patent Application Publication
(10) Pub. No.: US 2016/0369729 A1
(43) Pub. Date: Dec. 22, 2016

(54) CONTROL APPARATUS AND CONTROL METHOD FOR INTERNAL COMBUSTION ENGINE

(71) Applicant: TOYOTA JIDOSHA KABUSHIKI KAISHA, Toyota-shi (JP)

(72) Inventor: Masatoshi YOSHINAGA, Nagoya-shi (JP)

(73) Assignee: TOYOTA JIDOSHA KABUSHIKI KAISHA, Toyota-shi (JP)

(21) Appl. No.: 15/163,031

(22) Filed: May 24, 2016

(30) Foreign Application Priority Data
Jun. 19, 2015 (JP) 2015-123610

(51) Int. Cl. F02D 41/14; F01L 1/344; F01L 1/04

(52) U.S. Cl. CPC F02D 41/1486; F01L 1/04; F01L 1/344

(57) ABSTRACT

An air-fuel ratio sensor is disposed downstream of an aggregated portion of an exhaust manifold, a ratio of an amount of intake air flowing out to an exhaust port in an overlap period of an intake valve and an exhaust valve to an amount of intake air sucked into each of cylinders (an intake air blow-by ratio: a scavenging ratio) is calculated based on an operation state of an engine. A detected air-fuel ratio is corrected in accordance with this scavenging ratio.

### INCORPORATION BY REFERENCE

The disclosure of Japanese Patent Application No. 2015-123610 filed on Jun. 19, 2015 including the specification, drawings and abstract is incorporated herein by reference in its entirety.

### BACKGROUND

### 1. Technical Field

The disclosure relates to a control apparatus and a control method for an internal combustion engine that is mounted in a vehicle or the like, and more particularly, to a control apparatus that performs feedback control of an air-fuel ratio based on a value detected by an air-fuel ratio sensor that is provided in an exhaust system.

### 2. Description of Related Art

A catalyst for removing noxious components in exhaust gas is disposed in an exhaust system of an internal combustion engine that is mounted in a vehicle such as an automobile or the like. In order to ensure that this catalyst sufficiently exerts its function, the air-fuel ratio of exhaust gas is feedback-controlled to the vicinity of a theoretical air-fuel ratio. For example, it is disclosed in Japanese Patent Application Publication No. 2013-238111 (JP 2013-238111 A) that the air-fuel ratio of exhaust gas is controlled by correcting the amount of fuel injection in accordance with a difference between a value detected by an air-fuel ratio sensor that is provided in an exhaust system and a target air-fuel ratio after the detected value is moderated and corrected.

The Japanese Patent Application Publication No. 2013-238111 (JP 2013-238111 A) focuses attention on scavenging that a part of intake air that has flowed into each of cylinders blows through an exhaust passage in an overlap period of an intake valve and an exhaust valve. To restrain the air-fuel ratio from fluctuating as a result of scavenging, it is also disclosed in this Japanese Patent Application Publication No. 2013-238111 (JP 2013-238111 A) that, the amount of fuel injection is corrected, in an operation state (a scavenging range) where scavenging occurs, based on an instantaneous value which is detected by the air-fuel ratio sensor and not moderated or corrected.

### SUMMARY

When scavenging occurs as mentioned earlier and a part of intake air blows through the exhaust passage, the amount of intake air with which the interior of each of the cylinders is filled decreases accordingly. Therefore, the air-fuel ratio of the air-fuel mixture may shift toward the rich side from the target air-fuel ratio. In this case, the air-fuel ratio of burnt gas (exhaust gas) flowing out to the exhaust passage in the former half of an exhaust stroke of each of the cylinders becomes rich, but turns lean in an overlap period at the last stage of the exhaust stroke because intake air blows through as mentioned earlier.

Then, in a multi-cylinder engine that is mounted in a vehicle, exhaust gases discharged from a plurality of cylinders flow to mix with one another in an aggregated portion of an exhaust manifold. It has been revealed, however, that when the air-fuel ratios of the exhaust gases thus mixing with one another greatly change to become rich or lean, the value detected by the air-fuel ratio sensor shifts toward the rich side with respect to an average of those air-fuel ratios.

In this manner, when the value detected by the air-fuel ratio sensor shifts toward the rich side, the air-fuel ratio becomes leaner than the theoretical air-fuel ratio through feedback control based on this detected value, and inconveniences such as an increase in the discharge amount of NOx occur. Incidentally, the detected value is also considered to shift toward the lean side in the case of certain types of the air-fuel ratio sensor or certain layouts of the exhaust system.

A control apparatus and a control method for an internal combustion engine that appropriately corrects a shift in a detected value of an exhaust gas air-fuel ratio resulting from scavenging, and enhances the controllability of the air-fuel ratio in the internal combustion engine is provided.

The invention is applied to a control apparatus for an internal combustion engine that performs feedback control of an air-fuel ratio based on a value detected by an air-fuel ratio sensor that is provided in an exhaust system. The internal combustion engine has a plurality of cylinders. The air-fuel ratio sensor is disposed downstream of an aggregated portion of exhaust passages through which exhaust gases from the plurality of the respective cylinders flow, with respect to flow of the exhaust gases.

Then, the control apparatus is characterized by being equipped with blow-by ratio calculation means for calculating an intake air blow-by ratio, which is a ratio of an amount of intake air flowing out to each of the exhaust passages in an overlap period of an intake valve and an exhaust valve to an amount of intake air sucked into each of the cylinders in a suction stroke, based on an operation state of the internal combustion engine, and detected air-fuel ratio correction means for correcting the value detected by the air-fuel ratio sensor such that a degree of correction increases as the calculated intake air blow-by ratio rises, in accordance with the intake air blow-by ratio.

An aspect of the invention can also be defined as follows. That is, a control apparatus for an internal combustion engine is provided. The internal combustion engine includes a plurality of cylinders and an air-fuel ratio sensor. The air-fuel ratio sensor is disposed downstream of an aggregated portion of exhaust passages through which exhaust gases from the plurality of the respective cylinders flow, with respect to flow of the exhaust gases. The control apparatus includes an electronic control unit. The electronic control unit is configured to perform feedback control of an air-fuel ratio based on a value detected by the air-fuel ratio sensor, and calculate an intake air blow-by ratio based on an operation state of the internal combustion engine. The intake air blow-by ratio is a ratio of an amount of intake air flowing out to each of the exhaust passages in an overlap period of an intake valve and an exhaust valve to an amount of intake air sucked into each of the cylinders in a suction stroke. The electronic control unit is also configured to correct the value detected by the air-fuel ratio sensor such that a degree of correction increases as the calculated intake air blow-by ratio rises.

During the operation of the internal combustion engine as mentioned earlier, exhaust gases flowing from the plurality of the cylinders converge at the aggregated portion of the exhaust passages, and feedback control of the air-fuel ratio is performed in accordance with the value detected by the air-fuel ratio sensor that is located downstream of the aggregated portion. Then, when the air-fuel ratios of the exhaust gases greatly change toward the rich side or the lean side due to the blow-by of intake air and the exhaust gases reach the air-fuel ratio sensor before sufficiently mixing with one another, a shift in the value detected by this air-fuel ratio sensor (a shift in detection) is caused.

In contrast, due to the foregoing specific matter, first of all, the blow-by ratio of intake air blowing through the exhaust passages as a result of scavenging is calculated based on the operation state of the internal combustion engine, by the blow-by ratio calculation means. The value of the air-fuel ratio detected by the air-fuel ratio sensor is corrected in accordance with this blow-by ratio of intake air, by the detected air-fuel ratio correction means. In accordance with the calculated blow-by ratio of intake air, the degree of this correction is increased as the calculated blow-by ratio of intake air rises. Therefore, it is possible to appropriately correct the shift in detection of the air-fuel ratio resulting from scavenging, and enhance the controllability of the air-fuel ratio.

In more concrete terms, in the case of a conventionally employed general air-fuel ratio sensor, the detected value shifts toward the rich side as described above. Therefore, the detected air-fuel ratio correction means may correct the value detected by the air-fuel ratio sensor toward the lean side as the blow-by ratio of intake air rises. This makes it possible to restrain the air-fuel ratio from shifting toward the lean side through feedback control that is performed based on the detected value, and to prevent the occurrence of inconveniences such as an increase in the discharge amount of NOx and the like.

By the way, internal combustion engines of recent years are often equipped with a variable valve mechanism. The variable valve mechanism is operated in accordance with the operation state, and the valve timing of at least one of the intake valve and the exhaust valve is changed. In this case, when the overlap period of the intake valve and the exhaust valve becomes short due to, for example, retardation of the valve timing of the intake valve or advancement of the valve timing of the exhaust valve, scavenging cannot occur. Therefore, there is no need to correct the detected value of the air-fuel ratio as mentioned earlier.

Thus, a short overlap period of the intake valve and the exhaust valve in which scavenging cannot occur may be found out in advance through an experiment or the like, and this overlap period may be set as a threshold. The correction by the detected air-fuel ratio correction means may be prohibited when the overlap period of the intake valve and the exhaust valve becomes shorter than the threshold during the operation of the internal combustion engine. In this manner, an inconvenience of a shift in the air-fuel ratio through feedback control as an opposite effect can be prevented from being caused due to the subjection of the detected value of the air-fuel ratio to an unnecessary correction.

The foregoing threshold may be set in such a manner as to change in accordance with at least one of an engine rotational speed, an intake pressure and an atmospheric pressure. The likelihood of the occurrence of the blow-by of intake air resulting from scavenging increases as the time equivalent to the overlap period of the intake valve and the exhaust valve lengthens, and as the intake pressure rises with respect to the exhaust pressure. Therefore, if the foregoing threshold is appropriately changed in accordance with the engine rotational speed, the intake pressure, the atmospheric pressure or the like, it can be more appropriately determined whether or not scavenging occurs.

As described above, in accordance with the control apparatus for the internal combustion engine according to the invention, focusing attention on the fact that the shift in detection of the air-fuel ratio by the air-fuel ratio sensor increases as the blow-by ratio of intake air resulting from scavenging rises, the detected value of the air-fuel ratio is corrected in accordance with the blow-by ratio of intake air that is calculated based on the operation state of the internal combustion engine. Therefore, it is possible to appropriately correct the shift in detection of the air-fuel ratio resulting from scavenging, and to enhance the controllability of the air-fuel ratio through feedback control.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a schematic block diagram showing an exemplary engine in a vehicle that is mounted with a control apparatus for an internal combustion engine according to the invention;

FIG. 2 is a schematic block diagram showing only one cylinder of the engine of FIG. 1;

FIG. 3 is a view showing exemplary lift curves of an intake valve and an exhaust valve;

FIG. 4 is a view schematically showing the blow-by of intake air and equivalent to FIG. 2;

FIG. 5 is a graphic view of an experimental result showing how a scavenging ratio and a shift in detection of an air-fuel ratio are correlated with each other;

FIG. 6 is a flowchart of a process of correcting a detected air-fuel ratio;

FIG. 7 is a graphic view of an experimental result showing how an overlap period of the valves and the scavenging ratio are correlated with each other;

FIG. 8 is a view equivalent to FIG. 6 according to a first modification example;

FIG. 9 is an image view showing how the overlap period of the valves, the scavenging ratio and an output voltage correction value are correlated with one another in the first modification example; and

FIG. 10 is a flowchart showing a process of setting a correction prohibition threshold of the detected air-fuel ratio in a second modification example.

### DETAILED DESCRIPTION OF EMBODIMENTS

An embodiment will be described hereinafter based on the drawings. In the present embodiment of the invention, a case where the invention is applied to an internal combustion engine (hereinafter referred to also as the engine) that is mounted in a vehicle such as an automobile or the like will be described.

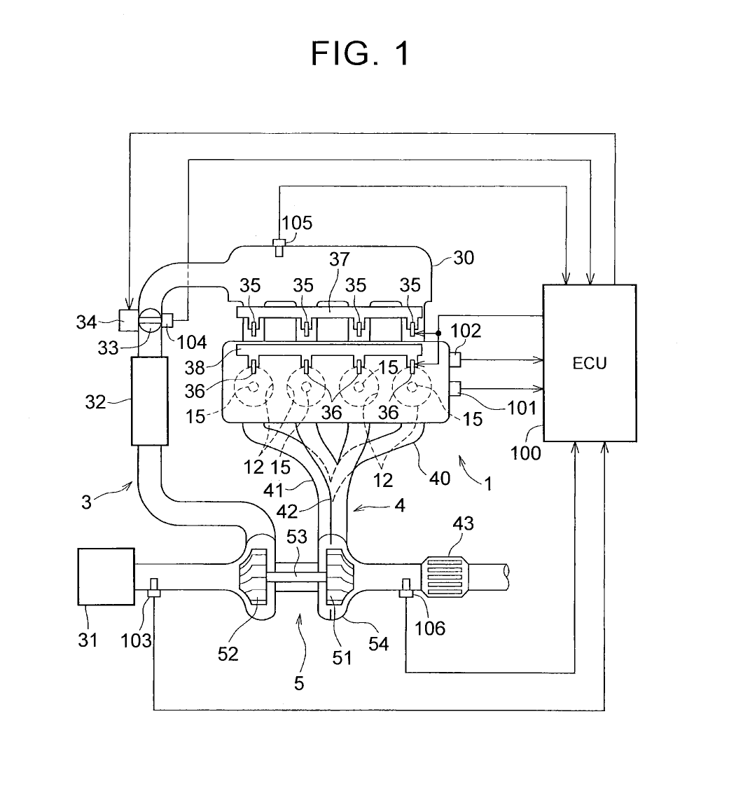

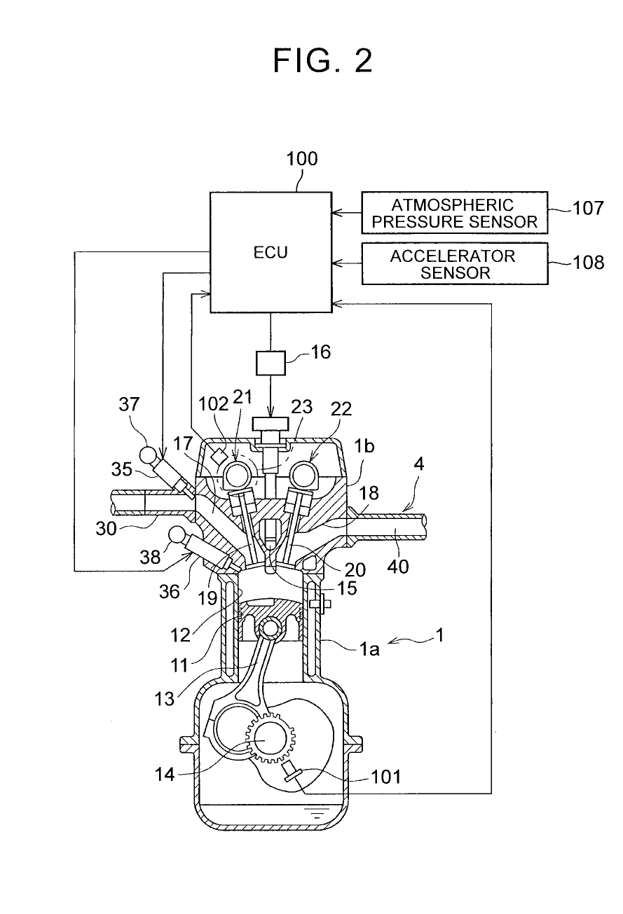

As schematically shown in FIG. 1, four cylinders 12, namely, the first to fourth cylinders 12, each of which accommodates a piston 11, are provided in alignment in an engine 1. In FIG. 2, as shown as to one of the cylinders 12 formed in a cylinder block 1a, the piston 11 is coupled to a crankshaft 14 by a connecting rod 13, and a crank angle sensor 101 that detects a rotational angle (a crank angle) of the crankshaft 14 is disposed in a lower portion of the cylinder block 1a.

On the other hand, a cylinder head 1b is assembled with an upper portion of the cylinder block 1a. An ignition plug 15 is disposed in such a manner as to face the interior of each of the cylinders 12, and is supplied with electric power from an igniter 16 to discharge sparks. Besides, an intake port 17 and an exhaust port 18 are formed in the cylinder head 1b in such a manner as to communicate with a combustion chamber in each of the cylinders 12. Opening portions facing the interior of each of the cylinders 12 is opened/closed by an intake valve 19 and an exhaust valve 20.

A valve train that operates this intake valve 19 and this exhaust valve 20 is equipped with two camshafts 21 and 22, namely, the intake camshaft 21 and the exhaust camshaft 22, which are rotated by the crankshaft 14 via a timing chain (not shown) and a sprocket (not shown). Besides, a cam angle sensor 102 is provided in the vicinity of the intake camshaft 21 in such a manner as to generate a pulse-like signal when a specific one of the cylinders 12 is located at a predetermined crank angle position (at a predetermined position in a combustion cycle of suction, compression, expansion and exhaust).

The intake camshaft 21 (and the exhaust camshaft 22) rotates at half a speed of the crankshaft 14. Therefore, the cam angle sensor 102 generates a signal every time the crankshaft 14 rotates twice (changes by 720° in crank angle). In consequence, a crank angle position in the combustion cycle of each of the cylinders 12 can be recognized based on a signal of this cam angle sensor 102 and a signal of the crank angle sensor 101.

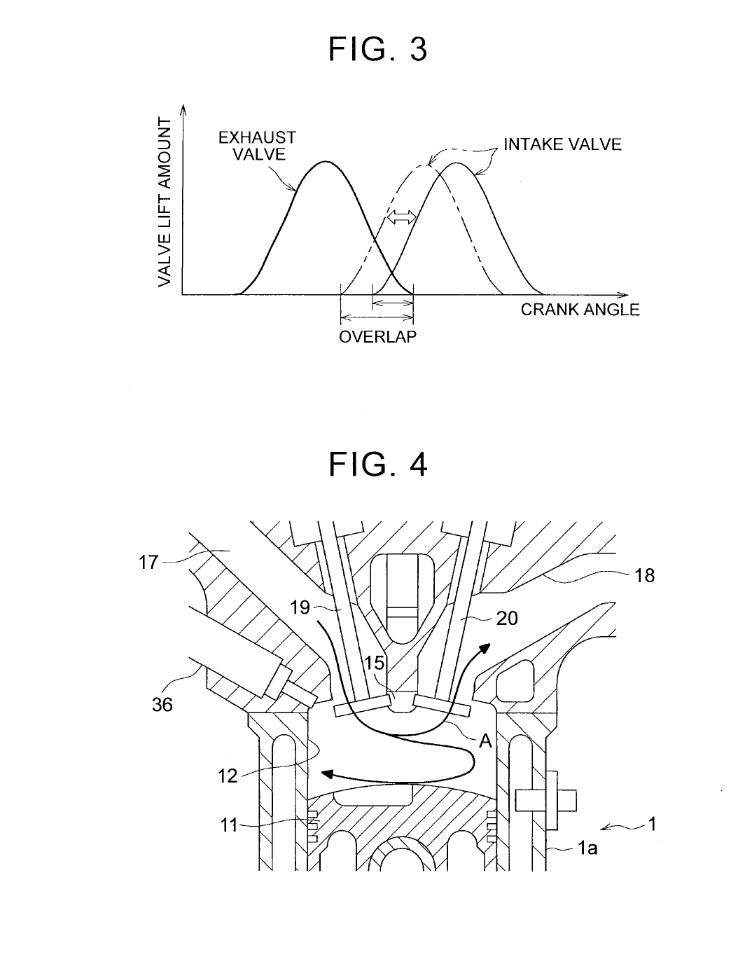

In the present embodiment of the invention, a variable valve mechanism 23 (hereinafter referred to as the VVT 23) is attached to the intake camshaft 21. The variable valve mechanism 23 can continuously change the phase of the rotational angle of the intake camshaft 21 with respect to the crank angle. Although not described in detail, the VVT 23 is electrically or hydraulically operated. As schematically shown in FIG. 3, the VVT 23 can change the valve timing of the intake valve 19 to an advancement side or a retardation side by turning the intake camshaft 21 and the sprocket relatively to each other.

That is, when the sprocket is turned backward in the rotational direction of the intake camshaft 21 by, for example, 15° through the operation of the VVT 23, the phase of the intake camshaft 21 advances by 30° in crank angle, and the valve timing of the intake valve 19 advances by 30° as indicated by a fictitious line in FIG. 3. At this moment, a signal from the cam angle sensor 102 is output earlier by 30° in crank angle. Thus, the advancement of the valve timing of the intake valve 19 can be recognized.

As is apparent in FIG. 1, an intake manifold 30 is connected to each of the cylinders 12 upstream of the intake port 17 (upstream with respect to the flow of intake air). In an intake passage 3 that is located upstream of the intake manifold 30, an air cleaner 31, an airflow meter 103, a compressor 52 of a turbosupercharger 5 that will be described later, an intercooler 32, a throttle valve 33 for adjusting the amount of intake air, and the like are arranged in this order from the upstream side. The throttle valve 33 is driven by a throttle motor 34. A throttle sensor 104 detects an opening degree of the throttle valve 33.

Besides, an intake pressure sensor 105 is disposed in the intake manifold 30, and detects a pressure of intake air supercharged by the turbosupercharger 5. In a branch passage that is located downstream of the intake pressure sensor 105, a port injector 35 is disposed in such a manner as to inject fuel into the intake port 17 of each of the cylinders 12. In addition to this port injector 35, an in-cylinder injection injector 36 is also disposed in such a manner as to directly inject fuel into each of the cylinders 12. Fuel can be injected even after the intake valve 19 is closed in a compression stroke of each of the cylinders 12.

The port injector 35 and the in-cylinder injection injector 36 are connected to a low-pressure delivery pipe 37 and a high-pressure delivery pipe 38 respectively, and are supplied with fuel via a fuel pipeline (not shown). Then, when fuel is injected by at least either the injector 35 or the injector 36, an air-fuel mixture is formed in each of the cylinders 12. The air-fuel mixture in each of the cylinders 12 is ignited by the ignition plug 15 and burns. The air-fuel mixture that has thus burned (burnt gas) flows out to the exhaust port 18 as the exhaust valve 20 opens.

As is apparent in FIG. 1, an exhaust manifold 40 is connected to each of the cylinders 12 downstream of the exhaust port 18 (downstream with respect to the flow of exhaust gas), and constitutes an upstream end portion of the exhaust passage 4. A turbine 51 of the turbosupercharger 5 is disposed downstream of the exhaust manifold 40. The turbine 51 is coupled to the compressor 52 on the intake side by a coupling shaft 53. When the turbine 51 rotates due to the flow of exhaust gas, the compressor 52 rotates integrally therewith to compress and force-feed intake air.

In the present embodiment of the invention, the turbine 51 is of a twin entry type (a twin scroll type) in which a flow channel in a housing 54 is divided into two flow channels. A first exhaust passage 41 in the exhaust manifold 40 communicates with one of the flow channels, and a second exhaust passage 42 in the exhaust manifold 40 communicates with the other flow channel of the housing 54. The first exhaust passage 41 is bifurcated on the upstream side thereof to be connected to the first cylinder 12 and the fourth cylinder 12. The second exhaust passage 42 is bifurcated on the upstream side thereof to be connected to the second cylinder 12 and the third cylinder 12.

Thus, exhaust gas discharged from the first cylinder 12 and exhaust gas discharged from the fourth cylinder 12 converge in the first exhaust passage 41 to flow into one of the flow channels of the housing 54 of the turbine 51. On the other hand, exhaust gas discharged from the second cylinder 12 and exhaust gas discharged from the third cylinder 12 converge in the second exhaust passage 42 to flow into the other flow channel of the housing 54. That is, exhaust gases in the two cylinders 12 that are not consecutive in ignition sequence to each other converge. Therefore, the interference of exhaust gases between the cylinders 12 can be suppressed, and the responsiveness of supercharging is enhanced.

Then, a three-way catalyst 43 for purifying exhaust gas is installed in the exhaust passage 4 downstream of the turbine 51. As will be described later, when the air-fuel ratio of exhaust gas is subjected to feedback control and held close to a theoretical air-fuel ratio, the three-way catalyst 43 exhibits high exhaust gas purification performance by reducing NOx while oxidizing the CO and HC in exhaust gas. For the sake of this air-fuel ratio feedback control, an air-fuel ratio sensor 106 that exhibits substantially linear output characteristics for the air-fuel ratio of exhaust gas is arranged upstream of the three-way catalyst 43.

An ECU 100 is configured as a known electronic control unit, and is equipped with a central processing unit (a CPU), a read only memory (a ROM), a random access memory (a RAM), a backup RAM and the like, although not shown in the drawings. The CPU executes various computation processes based on control programs and maps stored in the ROM. Besides, the RAM temporarily stores computation results in the CPU, data input from the respective sensors, and the like. The backup RAM stores, for example, data to be saved at the time of stop of the engine 1, and the like.

The foregoing crank angle sensor 101, the cam angle sensor 102, the airflow meter 103, the throttle sensor 104, the intake pressure sensor 105, the air-fuel ratio sensor 106 and the like are connected to the ECU 100. Besides, as shown in FIG. 2, an atmospheric pressure sensor 107 and an accelerator sensor 108 that detects an amount of operation of an accelerator pedal by a passenger of the vehicle (an accelerator opening degree) are connected to the ECU 100.

Based on signals input from these various sensors 101 to 108 and the like, the ECU 100 executes various control programs, and thereby performs the control of the ignition timing by the igniter 16, the control of the throttle opening degree by the throttle motor 34 (i.e., the control of the amount of intake air), the control of fuel injection by the port injectors 35 and the in-cylinder injection injectors 36, and the like. For example, the ECU 100 performs the foregoing control of the ignition timing, the amount of intake air and fuel injection in such a manner as to realize a torque required of the engine 1.

In this case, the ECU 100 performs feedback control of the amount of fuel injection to hold the air-fuel ratio of exhaust gas close to the theoretical air-fuel ratio. That is, first of all, while performing the control of the amount of intake air such that the foregoing required torque can be generated, the ECU 100 calculates an intake air filling efficiency of each of the cylinders 12 based on a flow rate of intake air detected by the airflow meter 103 and an engine rotational speed, and calculates a basic fuel injection amount such that the theoretical air-fuel ratio is achieved correspondingly. Then, the ECU 100 calculates a feedback correction coefficient for correcting the amount of fuel injection in accordance with a difference between a value detected by the air-fuel ratio sensor 106 (a detected air-fuel ratio) and the theoretical air-fuel ratio, and calculates a control target value of the amount of fuel injection from this feedback correction coefficient and the basic fuel injection amount.

Besides, the ECU 100 operates the VVT 23 in accordance with the operation state of the engine 1, and changes the operation timing of the intake valve 19 as needed. For example, in a low load-side operation state, the ECU 100 retards the timing for closing the intake valve 19 to attempt to reduce the pumping loss. On the other hand, on a high load side, the ECU 100 advances the timing for closing the intake valve 19 to enhance the filling efficiency of the intake air flowing into each of the cylinders 12 and attempt to enhance the output. At this moment, the timing for opening the intake valve 19 is also advanced, so the overlap period of the intake valve and the exhaust valve becomes long. As a result, the scavenging properties of burnt gas are improved.

By the way, in the present embodiment of the invention, intake air is supercharged by the turbosupercharger 5, so the intake pressure may become higher than the exhaust pressure. When the overlap period of the intake valve and the exhaust valve becomes long as mentioned earlier, the blow-by (scavenging) of a part of the intake air that has flowed into each of the cylinders 12 through the exhaust port 18 occurs as schematically indicated by an arrow A in FIG. 4. In accordance with the intake air that has thus blown through, the amount of intake air with which the interior of each of the cylinders 12 is filled decreases. Therefore, when fuel is thereafter injected by each of the in-cylinder injection injectors 36, the air-fuel ratio of the air-fuel mixture shifts toward the rich side from a target air-fuel ratio.

In this case, the air-fuel ratio of the burnt gas (exhaust gas) flowing out to the exhaust port 18 becomes rich in the former half of an exhaust stroke of each of the cylinders 12. However, in an overlap period of the intake valve and the exhaust valve from the last stage of the exhaust stroke to a suction stroke, the air-fuel ratio abruptly turns lean due to the blow-by of intake air as mentioned earlier. Then, it has been revealed that when the air-fuel ratios of exhaust gases from the respective cylinders 12 greatly fluctuate to become rich or lean, the air-fuel ratio detected by the air-fuel ratio sensor 106 shifts toward the rich side with respect to the average of those air-fuel ratios.

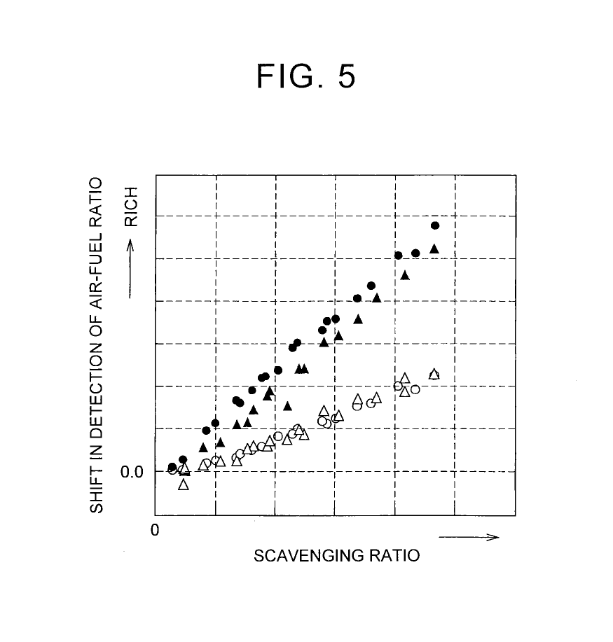

FIG. 5 shows an exemplary experimental result obtained by examining a shift in the detected air-fuel ratio resulting from scavenging as mentioned earlier. It is apparent that the shift in the detected air-fuel ratio toward the rich side increases as the scavenging ratio indicated by the axis of abscissa in the drawing rises. The scavenging ratio represents a ratio of the amount of intake air blowing through the exhaust side to the amount of intake air with which the interior of each of the cylinders 12 is filled as a denominator (a blow-by ratio of intake air), and is considered to correspond to the magnitude of fluctuations in exhaust gas air-fuel ratios toward the rich or lean side as mentioned earlier.

Besides, data indicated by black triangles and black circles in FIG. 5 are experimental data in the case where an air-fuel ratio sensor is provided upstream of the turbine of the turbosupercharger for reference. Data indicated by blank triangles and blank circles are experimental data in the case where the air-fuel ratio sensor 106 is provided downstream of the turbine 51 as in the present embodiment of the invention. Exhaust gases from the respective cylinders 12 are stirred and mix with one another in the turbine 51. Therefore, in comparison with the case where the air-fuel ratio sensor is provided on the upstream side (as indicated by the black triangles and the black circles), the magnitude of fluctuations in the air-fuel ratio is smaller, and the shift in detection is also considered to be smaller.

That is, as the range of fluctuations in exhaust gas air-fuel ratio resulting from scavenging increases, the shift in the air-fuel ratio detected by the air-fuel ratio sensor toward the rich side also increases. Incidentally, this shift in the detected air-fuel ratio is ascribable to the output characteristics of general air-fuel ratio sensors, and is considered to result from the facts that the saturation current value of a zirconia solid electrolyte corresponding to the concentration of oxygen in exhaust gas nonlinearly changes with respect to changes in exhaust gas air-fuel ratio, and that the changes in the saturation current value are more precipitous when the air-fuel ratio is rich than when the air-fuel ratio is lean.

Then, when the air-fuel ratio detected by the air-fuel ratio sensor 106 thus shifts toward the rich side, the amount of fuel injection is reduced in feedback control of the air-fuel ratio that is performed accordingly. As a result, the actual air-fuel ratio shifts toward the lean side, and an inconvenience such as an increase in the discharge amount of NOx may occur. In contrast, according to the present embodiment of the invention, feedback control of the air-fuel ratio is performed by appropriately correcting a shift in the detected air-fuel ratio resulting from scavenging as mentioned earlier, as follows.

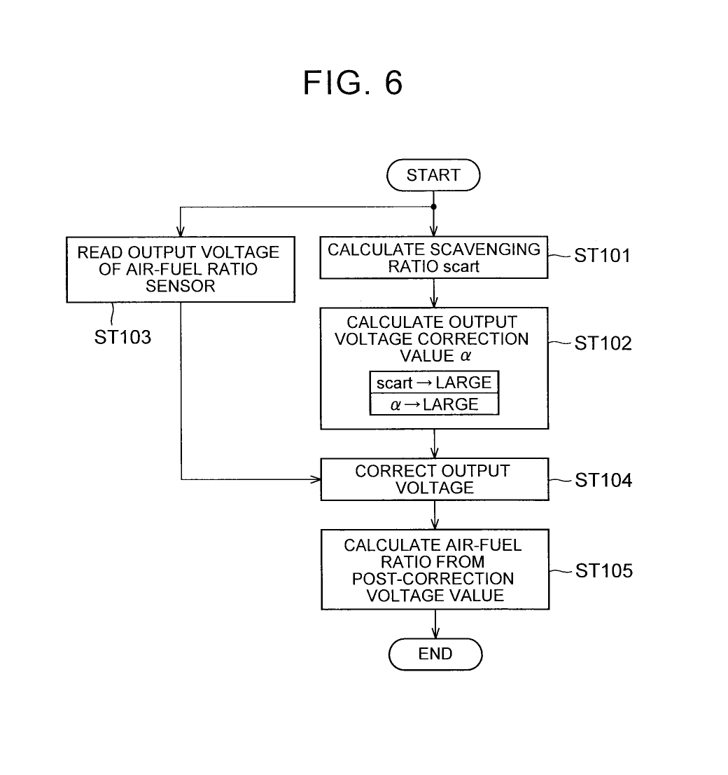

The correction of the detected air-fuel ratio that is carried out in the ECU 100 will be concretely described hereinafter, with reference to the flowchart of FIG. 6. Incidentally, a processing routine shown in the drawing is repeatedly executed in the ECU 100 at predetermined timings.

First of all, in step ST101 following the start, a scavenging ratio scart is calculated based on an operation state of the engine 1. As described above with reference to FIG. 4, the factors in the blow-by of a part of the intake air that has flowed into each of the cylinders 12 through the exhaust port 18 are considered to be lift amounts and lift periods of both the intake valve 19 and the exhaust valve 20 (an overlap period of the valves), a difference in pressure between intake air and exhaust gas, and the like.

That is, first of all, with the intake-side pressure higher than the exhaust-side pressure by a predetermined value or more, the lift amounts of both the intake valve 19 and the exhaust valve 20 need to be equal to or larger than a predetermined amount to achieve an effective opening area that can cause the flow of gas resulting from a difference in pressure between intake air and exhaust gas. The lift curves of the intake valve 19 and the exhaust valve 20 are determined as a specification of the engine. Therefore, the period in which the lift amounts of both the valves are equal to or larger than the predetermined amount can be specified in advance in consideration of the operation of the VVT 3 as well as the specification of the engine 1.

Besides, even when the flow of gas from the intake side to the exhaust side thus takes place, the burnt gas in each of the cylinders 12 is simply scavenged in early phase of the flow of gas, and the blow-by of intake air occurs after that. Therefore, the overlap period of the valves (strictly speaking, the period in which the foregoing flow of gas can take place) needs to be equal to or longer than a certain converted time. That is, as the difference in pressure between intake air and exhaust gas increases, as the effective opening area of the blow-by of intake air increases, and as the time of the blow-by of intake air lengthens, the blow-by amount of intake air increases. Therefore, in the present embodiment of the invention, the scavenging ratio is calculated using variables set in advance or a map, from the engine rotational speed, the overlap period of the intake valve and the exhaust valve, the intake pressure (the supercharging pressure), the exhaust pressure (approximated as the atmospheric pressure) and the like.

Then, an output voltage correction value a corresponding to the scavenging ratio scart thus calculated is calculated in step ST102. The preferable output voltage correction value a can be set based on the correlation of the scavenging ratio with the shift in the detected air-fuel ratio shown in the foregoing FIG. 5. Therefore, the output voltage correction value a corresponding to the scavenging ratio scart is calculated with reference to, for example, a table (see step ST102 of FIG. 6) that is set in advance in such a manner as to represent the foregoing correlation through experiments, calculation and the like.

On the other hand, in step ST103 in parallel with the steps ST101 and

ST102, an output (a voltage) of the air-fuel ratio sensor 106 is read. This output voltage is corrected with the foregoing output voltage correction value a (for example, the output voltage correction value a is subtracted from the voltage value) in step ST104. Then, an air-fuel ratio is calculated from the voltage value thus corrected (step ST105), and the process is ended. Incidentally, in this calculation, the air-fuel ratio may be calculated with reference to a map (not shown) based on, for example, the post-correction voltage value and an admittance, in consideration of changes in the temperature of the air-fuel ratio sensor 106.

By executing step ST101 in the flow of the foregoing FIG. 6, the ECU 100 constitutes blow-by ratio calculation means for calculating the blow-by ratio (the scavenging ratio “scart”) of intake air in the overlap period of the intake valve and the exhaust valve based on the operation state of the engine 1. Besides, by executing steps ST102 to ST104, the ECU 100 constitutes detected air-fuel ratio correction means for correcting the air-fuel ratio detected by the air-fuel ratio sensor 106 in accordance with the foregoing scavenging ratio scart. This detected air-fuel ratio correction means corrects the detected air-fuel ratio toward the lean side as the scavenging ratio scart rises.

In consequence, in accordance with the control apparatus for the engine 1 according to the present embodiment of the invention, the feedback correction coefficient of the amount of fuel injection is calculated in the ECU 100, in accordance with the difference between the detected air-fuel ratio corrected in accordance with the scavenging ratio as mentioned earlier and the target air-fuel ratio (the theoretical air-fuel ratio). Thus, the amount of fuel injection is corrected. Then, as mentioned earlier, the detected air-fuel ratio is corrected toward the lean side in accordance with the scavenging ratio calculated based on the operation state of the engine 1, as this scavenging ratio rises. Therefore, it is possible to appropriately correct the shift in detection of the air-fuel ratio resulting from scavenging, and to enhance the controllability of the air-fuel ratio through feedback control.

Next, modification examples of the foregoing embodiment of the invention will be described. The first modification example is a modification example regarding the correction of the detected air-fuel ratio described with reference to FIG. 6, and the detected air-fuel ratio is not corrected when the overlap period of the intake valve and the exhaust valve is short. The first modification example is identical in other details of configuration and operation to the aforementioned embodiment of the invention, so the difference therebetween will be mainly described hereinafter.

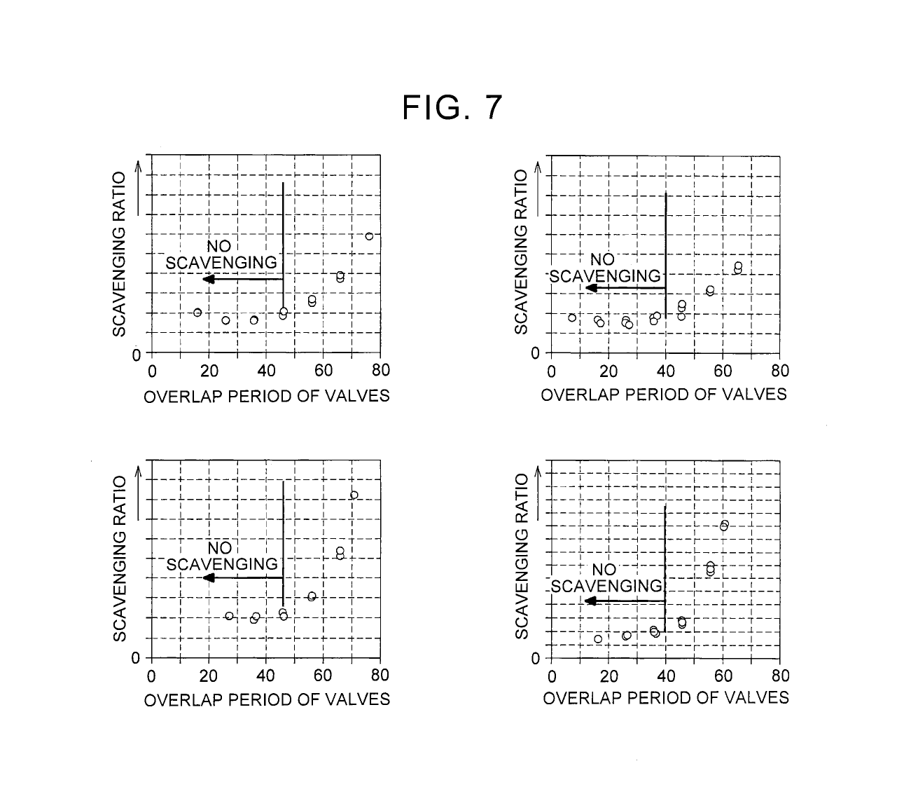

First of all, FIG. 7 shows an exemplary experimental result obtained by examining changes in the scavenging ratio while changing the overlap period of the valves respectively in four operation states that are different in engine rotational speed and intake pressure from one another. A graph in the upper left of the drawing indicates a high-load state where the engine rotational speed is low and close to an idling rotational speed and the intake pressure is relatively high, and a graph in the lower left of the drawing indicates a state where the engine rotational speed is equally low and the intake pressure is slightly higher. Besides, a graph in the upper right of the drawing indicates a state where the engine rotational speed is also slightly higher while the intake pressure remains high. A graph in the lower right of the drawing indicates a state where the intake pressure is still higher.

In each of these graphs, within a range where the overlap period of the valves indicated by the axis of abscissa is short (a range indicated by an arrow), the scavenging ratio is rather low. Moreover, the scavenging ratio does not change even when the overlap period of the valves changes. In view of the fact that unburnt air is contained in exhaust gas even when scavenging (the blow-by of intake air) has not occurred, scavenging is considered not to have occurred within the foregoing range.

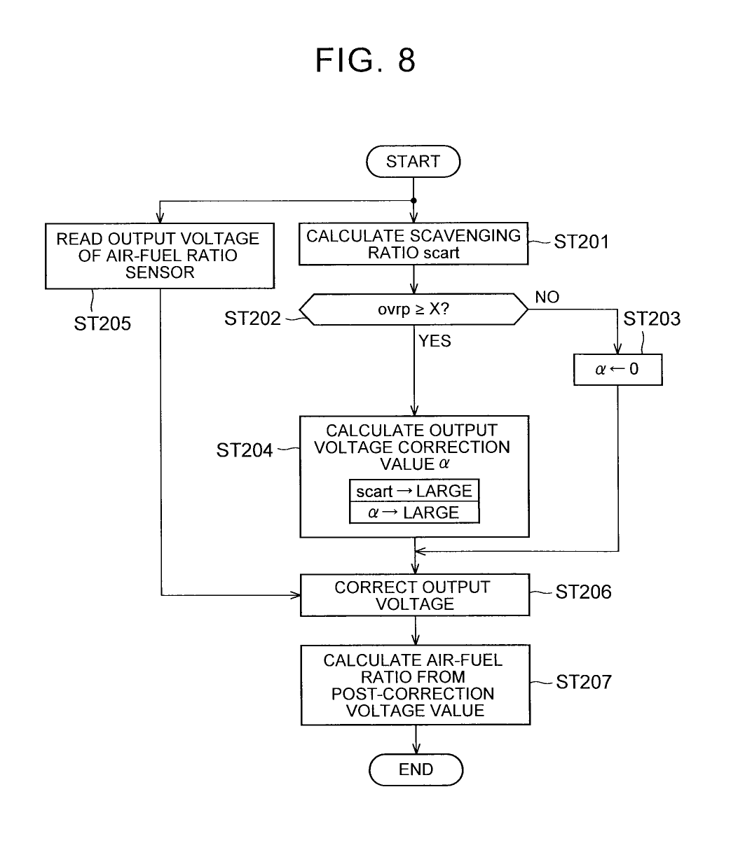

Based on the experimental result as in the foregoing FIG. 7, in this first modification example, when the overlap period of the intake valve and the exhaust valve is shorter than a predetermined threshold (e.g., 40° in crank angle in the foregoing example), the detected air-fuel ratio is prohibited from being corrected. That is, as shown in the flowchart of FIG. 8, in step ST201 following the start, the scavenging ratio scart is calculated in the same manner as in step ST101 of the flow of FIG. 6. After that, in step ST202, it is determined whether or not an overlap period ovrp of the intake valve and the exhaust valve is equal to or longer than the foregoing threshold X (hereinafter referred to as the correction prohibition threshold X).

It should be noted herein that the overlap period ovrp of the intake valve and the exhaust valve can be calculated based on signals from the crank angle sensor 101 and the cam angle sensor 102, in operation control of the VVT 23 that is performed by the ECU 100 as described above. Then, if the result of the determination is affirmative (YES) on the ground that the overlap period ovrp of the valves is equal to or longer than the correction prohibition threshold X, a transition to step ST204, which will be described later, is made. On the other hand, if the result of the determination is negative (NO) on the ground that the overlap period ovrp of the valves is shorter than the correction prohibition threshold X, a transition to step ST203 is made to set the output voltage correction value a to zero (0). Then, a transition to step ST206, which will be described later, is made.

In steps ST204 to ST207, a process of correcting the detected air-fuel ratio is executed according to the same procedure as in steps ST102 to ST105 of FIG. 6. That is, in step ST204 as well as step ST102, the output voltage correction value a corresponding to the scavenging ratio scart is calculated with reference to a table set in advance. It should be noted, however, that the output voltage correction value a is set to a value that is larger by a predetermined value al in this table than in the table that is used in step ST102.

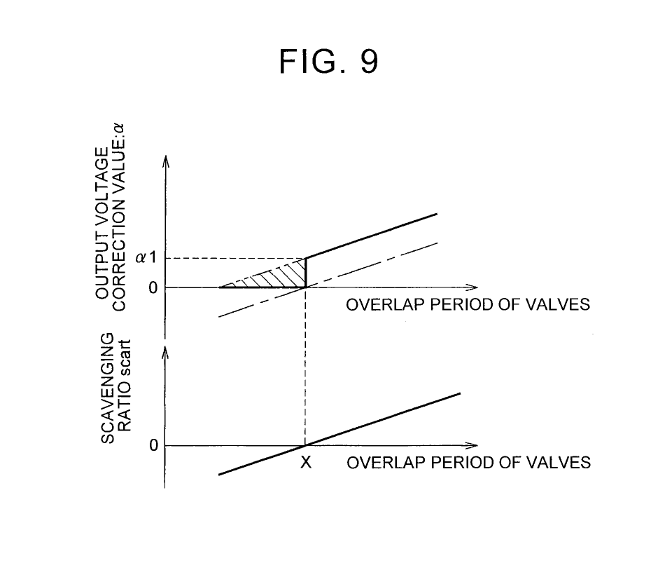

This is because of the following reason. In consideration of the fact that errors resulting from individual dispersion among the various sensors, aging and the like are contained in the scavenging ratio scart that is calculated as mentioned earlier, the output voltage correction value a corresponding to the scavenging ratio scart is set rather large with a view to compensating for the dispersion and the like. Specifically, as shown in FIG. 9 indicating how the overlap period of the valves, the scavenging ratio scart and the output voltage correction value a are correlated with one another, as the overlap period of the valves on the axis of abscissa lengthens, the scavenging ratio scart on the axis of ordinate increases, and the output voltage correction value a that is calculated accordingly also increases.

That is, the output voltage correction value a that is neither excessive nor deficient and that corresponds to the scavenging ratio scart is proportional to the scavenging ratio scart as indicated by an alternate long and short dash line in the upper stage of FIG. 9. However, the output voltage correction value a that is set rather large as mentioned earlier is a value that is larger by the predetermined value al as indicated by a solid line. As a result, within a range indicated by hatched lines in FIG. 9, although scavenging does not occur as the overlap period ovrp of the valves is shorter than the correction prohibition threshold X, a futile correction may be carried out with the output voltage correction value a that is set rather large.

In contrast, in this first modification example, if the overlap period ovrp of the valves is shorter than the correction prohibition threshold X as mentioned earlier (NO in step ST202), the output voltage correction value a is forcibly set to zero (0) (step ST203). Therefore, there is established a state indicated by the solid line in the upper stage of FIG. 9, and a futile correction is prevented from being carried out despite the non-occurrence of scavenging. In consequence, the output voltage of the air-fuel ratio sensor 106 is not corrected in step ST206 in this case. In step ST207, an air-fuel ratio is calculated from the uncorrected voltage value.

In this first modification example, the ECU 100 constitutes blow-by ratio calculation means by executing step ST201 of the flow of FIG. 8, and constitutes detected air-fuel ratio correction means by executing steps ST204 to ST206. Furthermore, by executing steps ST202 and ST203, the ECU 100 constitutes correction prohibition means for prohibiting the detected air-fuel ratio from being corrected when the overlap period ovrp of the intake valve and the exhaust valve is shorter than the correction prohibition threshold X.

In consequence, according to this first modification example, in the case where the overlap period ovrp of the intake valve and the exhaust valve is equal to or longer than the correction prohibition threshold X and fluctuations in the air-fuel ratio of exhaust gas have occurred as a result of scavenging, as the shift in the detected air-fuel ratio toward the rich side thus increases, the output voltage correction value a also increases. As is the case with the foregoing embodiment of the invention, it is possible to appropriately correct the shift in detection of the air-fuel ratio, and to enhance the controllability of the air-fuel ratio through feedback control. On the other hand, when the overlap period ovrp of the valves is shorter than the correction prohibition threshold X, the air-fuel ratio can be prevented from shifting, as an opposite effect, due to the execution of a futile correction despite the actual non-occurrence of scavenging.

Subsequently, the second modification example will be described. In this second modification example, the correction prohibition threshold X of the detected air-fuel ratio in the foregoing first modification example is changed depending on the engine rotational speed, the intake pressure and the atmospheric pressure. The second modification example is identical in other details of configuration and operation to the aforementioned first modification example, so the difference therebetween will be mainly described hereinafter.

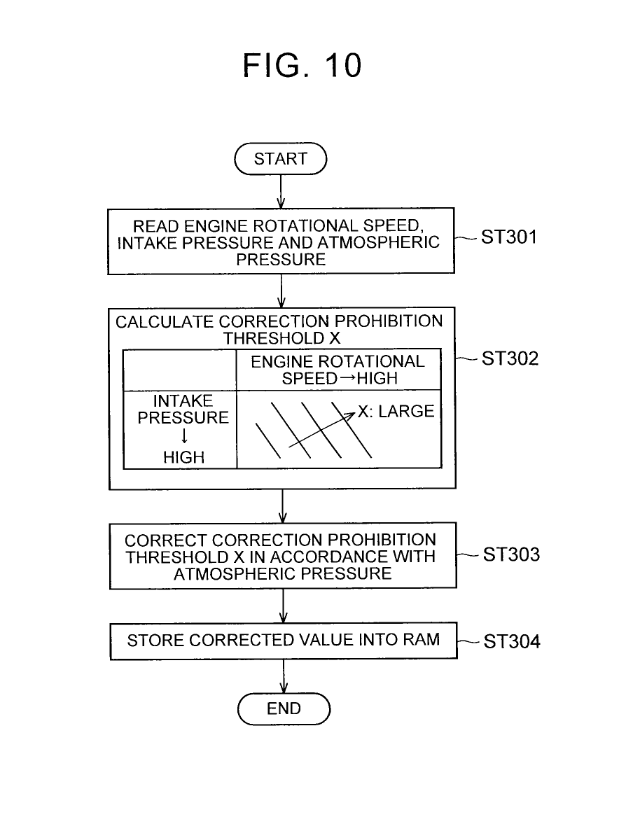

The flowchart of FIG. 10 shows a process of setting the correction prohibition threshold X of the detected air-fuel ratio in this second modification example. First of all, in step ST301 following the start, an engine rotational speed, an intake pressure and an atmospheric pressure are read. Incidentally, the engine rotational speed is calculated based on a signal from the crank angle sensor 101 in operation control of the engine I that is performed by the ECU 100. Besides, as for the intake pressure and the atmospheric pressure as well, values used for operation control of the engine 1 may be read, or signals from the intake pressure sensor 105 and the atmospheric pressure sensor 107 may be input as appropriate.

Subsequently in step ST302, the correction prohibition threshold X is read with reference to a map that is set in advance in such a manner as to correspond to the engine rotational speed and the intake pressure. In this map, suitable values are set through experiments, calculation and the like with the aid of a standard machine for each type of engine. As the engine rotational speed rises, the overlap period of the valves shortens, so the correction prohibition threshold X is set to a large value. As the intake pressure rises, the likelihood of the blow-by of intake air increases, so the correction prohibition threshold X is set to a small value.

The correction prohibition threshold X thus calculated is corrected in accordance with the atmospheric pressure in step ST303. For instance, this correction may be carried out through multiplication by a correction coefficient corresponding to the atmospheric pressure. The value of the correction coefficient is set, for example, to 1 on a flatland, and to 0.5 on a highland with an altitude of 5000 m. That is, if the atmospheric pressure is low as on a highland, this means that the exhaust pressure is also low, and the blow-by of intake air is likely. Therefore, the correction prohibition threshold X is corrected to a small value.

The correction prohibition threshold X that is appropriately corrected in accordance with the engine rotational speed, the intake pressure and the atmospheric pressure in this manner is stored into the RAM of the ECU 100 in step ST304, and the process is ended (end). In step ST202 of the flow of the foregoing FIG. 8, this value is read from the RAM of the ECU 100, and is used to determine whether or not the overlap period ovrp of the intake valve and the exhaust valve is equal to or longer than the correction prohibition threshold X. Thus, it can be more appropriately determined whether or not scavenging has occurred.

The embodiment of the invention described above is nothing more than an exemplification, and is not intended to limit the configuration, purpose of use and the like of the invention. For example, in the foregoing embodiment of the invention (including the modification examples), the air-fuel ratio detected by the air-fuel ratio sensor 106 is corrected toward the lean side as the scavenging ratio rises, but the invention is not limited thereto. The detected air-fuel ratio is also considered to shift toward the lean side in the case of certain structures of the air-fuel ratio sensor or certain layouts of the exhaust system. In this case, therefore, the detected air-fuel ratio may be corrected toward the rich side.

Besides, in the second modification example of the foregoing embodiment of the invention, the threshold for determining whether to correct the detected air-fuel ratio or not (the correction prohibition threshold X) is changed in accordance with the engine rotational speed, the intake pressure and the atmospheric pressure, but the invention is not limited thereto. The threshold may be changed in accordance with at least one of the engine rotational speed, the intake pressure and the atmospheric pressure.

Furthermore, although the case where the invention is applied to the gasoline engine 1 has been described as an example in the foregoing embodiment of the invention, the invention is not limited thereto either but can also be applied to other types of engines such as a diesel engine and the like. The invention is also applicable to an engine of a hybrid vehicle (a vehicle that is mounted with the engine and an electric motor as driving force sources).

The invention makes it possible to appropriately correct a shift in detection of the exhaust gas air-fuel ratio resulting from the blow-by (scavenging) of intake air in an overlap period of an intake valve and an exhaust valve, and to enhance the controllability of the air-fuel ratio. Therefore, the invention is highly effectively applicable especially to an internal combustion engine that is mounted in an automobile.

What is claimed is:

1. A control apparatus for an internal combustion engine, the internal combustion engine including a plurality of cylinders, and an air-fuel ratio sensor disposed downstream of an aggregated portion of exhaust passages through which exhaust gases from the plurality of the cylinders flow, with respect to flow of the exhaust gases, the control apparatus comprising
an electronic control unit configured to:
perform feedback control of an air-fuel ratio based on a value detected by the air-fuel ratio sensor;
calculate an intake air blow-by ratio based on an operation state of the internal combustion engine, the intake air blow-by ratio being a ratio of an amount of intake air flowing out to each of the exhaust passages in an overlap period of an intake valve and an exhaust valve to an amount of intake air sucked into each of the cylinders in a suction stroke; and
correct the value detected by the air-fuel ratio sensor such that a degree of correction increases as the intake air blow-by ratio rises.

2. The control apparatus according to claim 1, wherein
the electronic control unit is configured to correct the value detected by the air-fuel ratio sensor toward a lean side as the intake air blow-by ratio rises.

3. The control apparatus according to claim 1, wherein
the internal combustion engine further includes a variable valve mechanism, the variable valve mechanism is configure to change a valve timing of at least one of the intake valve and the exhaust valve, and
the electronic control unit is configured to prohibit the value detected by the air-fuel ratio sensor from being corrected when the valve timing of at least one of the intake valve and the exhaust valve is changed by the variable valve mechanism and the overlap period of the intake valve and the exhaust valve becomes shorter than a threshold.

4. The control apparatus according to claim 3, wherein
the threshold is set in such a manner as to change in accordance with at least one of an engine rotational speed, an intake pressure and an atmospheric pressure.

5. A control method for a vehicle including an internal combustion engine and
an electronic control unit, the internal combustion engine including a plurality of cylinders, an air-fuel ratio sensor disposed downstream of an aggregated portion of exhaust passages through which exhaust gases from the plurality of the cylinders flow, with respect to flow of the exhaust gases, the control method comprising:
performing feedback control of an air-fuel ratio, by the electronic control unit, based on a value detected by the air-fuel ratio sensor,
calculating an intake air blow-by ratio, by the electronic control unit, based on an operation state of the internal combustion engine, the intake air blow-by ratio being a ratio of an amount of intake air flowing out to each of the exhaust passages in an overlap period of an intake valve and an exhaust valve to an amount of intake air sucked into each of the cylinders in a suction stroke, and
correcting the value detected by the air-fuel ratio sensor such that a degree of correction increases as the intake air blow-by ratio rises, by the electronic control unit.
